(19) United States
(12) Patent Application Publication
(10) Pub. No.: US 2026/0298617 A2
(43) Pub. Date: Oct. 1, 2026

(54) Measuring Machine Quill Interface

(71) Applicant: Armin Konrad, Hüttenberg (DE)

(72) Inventor: Armin Konrad, Hüttenberg (DE)

(73) Assignee: Hexagon Metrology GmbH, Wetzlar (DE)

(21) Appl. No.: 19/330,492

(22) Filed: Sep. 16, 2025

(30) Foreign Application Priority Data
Oct. 2, 2024 (EP) 24204185.3

(51) Int. Cl. G01B 11/00; G01B 21/04

(52) U.S. Cl. CPC G01B 11/005; G01B 21/047

(57) ABSTRACT

The invention relates to a coordinate measuring machine with a sensor arranged on a quill or on a measuring system change interface and with a bearing device and with a holding device for the sensor arranged on the quill or on the measuring system change interface, and with at least one supply connection which is arranged between the quill or the measuring system change interface and the sensor, wherein the at least one supply connection has a plug and a coupling, with the plug and/or the coupling being arranged to be movable on the quill or on the measuring system change interface and/or on the sensor. The invention also relates to a method for arranging a sensor on a quill or a measuring system change interface.

### RELATED APPLICATIONS

This patent application claims priority from European Patent Application No. 24204185.3 filed on Oct. 2, 2024, which is hereby incorporated by reference in its entirety.

### FIELD OF THE INVENTION

The invention relates to a coordinate measuring machine with a quill or a measuring system change interface and a sensor arranged on the quill or on the measuring system change interface and with a bearing device that has at least one bearing arranged on the quill or on the measuring system change interface and at least one counter bearing arranged on the sensor, and with a holding device for the sensor arranged on the quill or on the measuring system change interface, and with at least one supply connection that is formed between the quill or the measuring system change interface and the sensor, wherein the at least one supply connection has a plug and a coupling. Furthermore, the invention relates to a method for arranging a sensor on a quill or on a reproducible measuring system change interface of a coordinate measuring machine, the sensor being arranged with counter bearings on bearings of the quill and at least one holding force being generated for the sensor and in which a contact is established between a plug and a coupling of at least one supply connection.

It is known from experience that tactile or measuring tactile and non-tactile sensors positioned on a coordinate measuring machine, either fixed in place or detachable, should be used for the dimensional measurement of workpieces with coordinate measuring machines.

The coordinate measuring machines known from experience consist of multiple moving axes that make it possible to move the sensor around in such a way that the geometry of workpieces can be measured.

The term sensors includes measuring heads, pivot/swivel joints, optical sensors or the like.

Tactile probes consist of a fixed part, which is permanently or detachably connected to an axis of the coordinate measuring machine, usually to a quill, and a part that can move relative to the fixed part, which holds a stylus consisting of an elongated shaft and a probing element such as a ball, the probing ball, attached at one end. Other probing elements are, for example, tips or spherical washers. The other end of the stylus is attached to the movable part of the probe, which moves relative to the fixed part when the probing element comes into contact with the surface of a workpiece. If the displacement of the stylus exceeds a predetermined value, contact with the workpiece is detected.

The measuring probes also have a fixed part that is permanently or detachably connected to an axis of the coordinate measuring device, usually to a quill, and a part that is movable relative to the fixed part. The displacement of the movable part relative to the fixed part is continuously measured by means of suitable measuring equipment. With switching probes, displacement is indicated simply by means of an electrical switching pulse. Return forces act on the movable part of the probe so that the probe is in a defined position relative to the fixed part of the probe when no external forces are acting on the stylus.

In addition, the prior art includes (DE 10 2004 010 083 B4) coordinate measuring machines in which the probes have rockers that are connected to one another via parallelogram spring plates.

In order to be able to perform as many different measuring tasks as possible, tactile or measuring probes have a mechanical interface into which different stylus configurations can be inserted or automatically exchanged.

The prior art (DE 10 2007 054 915 A1) also includes optical sensors with which a no-contact optical measuring method can be carried out.

In order to be able to measure complex objects, such as engine blocks, with a coordinate measuring machine, it is not only necessary to change the stylus configuration frequently, but also to change the probe or sensor relatively frequently, i.e., the measuring head or the pivot/swivel joint or the optical sensor. The sensor is usually positioned on a quill of the coordinate measuring machine. In so-called measuring head or sensor holders, different measuring heads or sensors or pivot/swivel joints can be held for various measuring tasks. These measuring heads or sensors or pivot/swivel joints are often exchanged in a fully automated manner by the coordinate measuring machine, depending on which measuring task requires the exchange of a specific measuring head or optical sensor or pivot/swivel joint. They can, however, also be exchanged manually as well.

Coordinate measuring devices known from practice, in particular coordinate measuring devices with a portal design, have a quill on which the sensor is replaceable and arranged with a reproducible bearing.

From practice, embodiments are also known in which a so-called measuring system change interface, also called interface, is arranged on the quill. The sensor, i.e., the pivot/swivel joint or the measuring head or the optical sensor, for example, is arranged interchangeably at the measuring system change interface.

When the sensor is arranged on the quill or on the measuring system change interface, a mechanical contact is established, which is formed by a reproducible bearing and a holding device, for example a hook. Supply connections are contacted as well. A sensor is supplied with electrical energy, for example, or the sensor is connected to the measuring system change interface or the quill via a data line. Hydraulic or pneumatic connections can be provided as well. In addition, optical sensors have optical connections that can be designed with contact or contactless.

It is known from practice that the contacts of the supply connections are made during the clamping process of the sensor on the quill or on the measuring system change interface. As is known from practice, the sensor is arranged for this purpose in a so-called three-point bearing on the quill or on the measuring system change interface. The clamping is carried out, for example, by using a hook. At the same time, a plug on the sensor engages with a coupling on the quill or on the measuring system change interface. The plug and socket can be swapped as well.

If the plug and coupling do not engage properly when clamping the sensor, this can have negative effects on the three-point bearing. However, there is also the possibility that the plug and coupling can be damaged if they are not connected properly. The pins of an electrical or electronic plug connection can be bent, for example.

Furthermore, the prior art includes (EP 1 706 703 B1) a mounting device for a coordinate measuring machine. According to this mounting device, a first holding force is generated by a magnet and the second holding force required for the measurement is generated by a clamping device. This mounting device is intended for manually changing a sensor device. Preloaded spring contact elements are provided for the creation of electrical contacts, for example. Each of these contact elements is preloaded with a specific preload force. This preload force generated by all contact elements must be overcome in addition to the weight force at the mounting position where the contact elements abut the corresponding contact surfaces of the second connecting element. This prior art mounting device has the disadvantage that these preload forces act on the quill during the arrangement of the sensor device and must be overcome.

The technical problem underlying the invention is to provide a coordinate measuring machine that avoids these disadvantages. Furthermore, a method for arranging a sensor on a spindle or on a measuring system change interface is to be specified, which allows for a reliable establishment of a contact of at least one supply connection.

This technical problem is solved by a coordinate measuring machine with the features under claim 1 and a method with the features under claim 9.

The coordinate measuring device according to the invention, with a sensor or an adapter for the sensor arranged on a quill or on a measuring system change interface, and with a bearing device, which has at least one bearing arranged on the quill or on the measuring system change interface and at least one counter bearing arranged on the sensor or the adapter, and with a holding device for the sensor or the adapter arranged on the quill or on the measuring system change interface, and with at least one supply connection, which is arranged between the quill or the measuring system change interface and the sensor or the adapter, wherein the at least one supply connection has a plug and a coupling, is characterized in that the plug or the coupling is movably arranged on the quill or on the measuring system change interface.

The coordinate measuring machine according to the invention has the advantage that the sensor is connected with as little force as possible.

Sensors include measuring heads, optical sensors, pivot/swivel joints or other measuring devices. The sensors can have an adapter for the arrangement on the quill or the measuring system change interface. The following statements refer to sensors and adapters for sensors equally, even if only sensors are referenced.

A measuring system change interface is an interface between the quill and the sensor.

The sensor is advantageously arranged with a three-point bearing on the quill or on the measuring system change interface. For this purpose, three bearings engage with three counter bearings, so that a six-point support is formed. This allows for a repeatable and highly reproducible bearing.

If the sensor is arranged on the quill or on the measuring system change interface, at least one supply connection for the sensor must be created in addition to the mechanical three-point bearing. The sensor, for example a tactile or measuring probe, requires at least one electronic data transmission line to the coordinate measuring machine. An optical sensor requires an optical interface, which can be created, for example, by arranging optical fibers in a ferrule.

The sensors require, for example, electrical, electronic, optical, pneumatic and/or hydraulic supply connections.

By establishing contact with the supply connection, forces act on the sensor in addition to the three-point bearing and the holding force.

An electrical connection is described below as an example. An electrical connection consists of a plug and a coupling. The plug is placed in the coupling to form the electrical connection.

If the plug is tilted or pins of the plug or the coupling are bent, an additional force is generated on the sensor when the sensor is arranged due to the improper connection of the plug to the coupling, which can have a negative effect on the three-point bearing. In addition, the plug and coupling can be destroyed.

In the coordinate measuring machine according to the invention, the sensor is arranged on the quill or on the measuring system change interface and the holding device for the sensor clamps the sensor. Because the plug and/or the coupling are arranged so that they can move on the spindle or on the measuring system change interface and/or on the sensor, the plug and/or the coupling are not brought into contact with the clamping of the sensor at the same time, but by moving the plug and/or the coupling, the contact between the plug and the coupling is carried out independently of the clamping of the sensor.

Advantageously, the force that is applied to move the plug and/or the coupling is smaller than the clamping force of the sensor, so that the sensor can be arranged on the quill or on the measuring system change interface in a repeatable and reproducible manner.

If it is detected during the movement of the plug and/or the coupling that contact cannot be established without problems, the process of coupling the plug and/or the coupling can be aborted or interrupted so that the plug and coupling are not damaged.

The coordinate measuring machine according to the invention makes it possible to connect the supply connection of the quill or measuring system change interface and the sensor only after the sensor has been arranged on the quill or on the measuring system change interface and clamped, i.e., the additional force for establishing the contact of the at least one supply connection is advantageously only applied after the sensor has been arranged in the end position for a measuring process.

The plug and/or the coupling are movably mounted on the quill or on the measuring system change interface or the sensor.

Particularly advantageous is that the holding force of the sensor is first generated on the quill and the sensor is reproducibly arranged on the quill by means of the three-point bearing. It is advantageous to not move the plug and/or the coupling until afterwards. The plug and/or the coupling are actively moved towards each other. There is no provision for a spring-loaded deflection of the plug or coupling.

The coordinate measuring machine according to the invention and the method according to the invention can be used particularly advantageously for an automatic sensor change. However, the sensor can also be replaced manually.

According to an advantageous embodiment of the invention, it is provided that the plug or the coupling is arranged on the quill or on the measuring system change interface and that the plug or the coupling is designed to be pneumatically, electrically and/or hydraulically movable.

It is possible that the plug is arranged on the quill or on the measuring system change interface and that the coupling is arranged on the sensor. It is also possible for the plug to be arranged on the sensor and the coupling on the quill or on the measuring system change interface.

The embodiment in which the plug or the coupling is arranged and movable on the quill or on the measuring system change interface has the advantage that the device for moving the plug or the coupling is arranged in or on the quill or the measuring system change interface, which in any case has pneumatic, electrical or hydraulic connections.

According to a further advantageous embodiment of the invention, the plug or the coupling is arranged on a piston and the piston is movably mounted in a cylinder and the cylinder is designed to be pressurized with compressed air.

This design is advantageous because compressed air does not cause contamination if a leak occurs. By arranging the piston in a cylinder, the plug or coupling is moved in a precise manner, allowing for repeatable and accurate positioning of the plug and coupling.

According to a further particularly preferred embodiment of the invention, it is provided that a holding device is provided for the sensor or adapter and that the holding device has a compressed air connection for generating a holding force of the sensor or adapter and that a compressed air connection is provided for the at least one supply connection and that both compressed air connections are designed to be coupled.

The holding force for the sensor is advantageously generated by using compressed air. For example, the sensor is pulled into the bearings of the quill or the measuring system change interface using a hook arranged on the quill or on the measuring system change interface. The holding force required for the measurement is advantageously generated with compressed air.

According to the advantageous embodiment, a compressed air connection is provided for the at least one supply connection. Advantageously, the cylinder in which the piston is arranged can be pressurized with compressed air. According to the particularly preferred embodiment of the invention, both compressed air connections are designed to be coupled. This embodiment has the advantage that when the holding force of the sensor is generated via the holding device, the contact of the supply connection between the plug and the coupling is established as well. No separate compressed air connection is required.

According to an alternative embodiment, it is provided that the plug or the coupling is arranged in the sensor or the adapter and that a motor is provided in the sensor or the adapter for moving the plug or the coupling. According to this embodiment, it is possible to move the plug arranged in the sensor or the coupling arranged in the sensor. In this case, the counterpart, which is arranged in the quill or the measuring system change interface, can be fixed. However, it is also possible for the plug and coupling to be movable in the sensor and in the quill or the measuring system change interface. This means that the plug and the coupling are both designed to be movable.

According to a further advantageous embodiment of the invention, it is provided that at least two force-generating devices are arranged in or on the measuring system change interface, and that they are designed as at least two force-generating devices acting on the holding device and that a first force-generating device is designed as a spring and that a second force-generating device is designed as a pneumatically operated piston.

This design has the advantage that the sensor can be replaced automatically. In addition, a reproducible mounting of the sensor on the quill or on the measuring system change interface is reliably ensured, since the generation of the first holding force pre-positions the sensor on the quill or on the measuring system change interface so that the bearing and counter bearing engage correctly. The second force-generating device generates the holding force required for the measurement. The first force-generating device is designed as a spring and the second force-generating device is designed as a pneumatic piston. This design of the coordinate measuring machine has the advantage that the spring can be arranged in the quill or the measuring system change interface in a space-saving manner. In addition, the spring does not have a lot of weight. The holding force required for the measurement can be generated in a simple manner by using the second force-generating device, which is advantageously designed as a pneumatically operated piston. The weight of this device consists mainly of the weight of the valves and an airtight space. These parts are very light as well.

This design prevents the sensor from being incorrectly placed with the counter bearings in the bearings arranged on the quill or on the measuring system change interface.

The bearings can, for example, be designed as balls and the counter bearings as so-called V-bearings, for example consisting of two cylinders. The counter bearings can also be designed as flat, V-or triple bearings. During the replacement process, it may happen that the bearings do not engage exactly with the counter bearings and that therefore the reproducible bearing is not guaranteed.

The design with the two holding forces avoids this. The first force is advantageously exerted by a first force-generating device and serves to pre-position the bearings in the counter bearings. Subsequently, the holding force required for the measurement is advantageously generated with the second force-generating device, for example the pneumatically operated piston.

The two force-generating devices are advantageously designed independently of each other. This means that the first and second force-generating devices can apply a force to the holding device independently of each other.

According to an advantageous embodiment of the invention, it is provided that the holding device is designed as a hook, for example as a clamping hook.

The holding device is advantageously arranged on or in the quill or the measuring system change interface. The hook design is mechanically very reliable.

According to a further advantageous embodiment of the invention, it is provided that at least one sensor is provided for detecting the position of the sensor or the adapter.

This embodiment has the advantage that after detecting that the sensor is arranged in the desired position, the two force-generating devices are automatically actuated. The first force-generating device, which is advantageously designed as a compression spring, can initially apply a force lower than the holding force required for the measurement, so that the bearings and the counter bearings assume the optimal position relative to one another. Afterwards, with a time delay, the second force-generating device can apply the holding force required for the measurement using air pressure.

The compression spring prevents the sensor from unintentionally detaching from the quill or the measuring system change interface in the event of a fault, if the second force-generating device fails.

It is advantageous to provide a sensor system that detects such an error. Then, the operation of the coordinate measuring machine can be stopped.

It is advantageously provided that the first force-generating device designed as a spring is designed as a force-generating device at least during the positioning of the sensor or the adapter and that the second force-generating device is designed as a device generating a holding force after the positioning of the sensor.

This particularly preferred embodiment has the advantage that the first force, namely the force generated by the first force-generating device, acts during the positioning of the sensor.

This allows the bearings and the counter bearings to be positioned precisely relative to each other. Subsequently, the second force is generated by the second force-generating device, namely the holding force for the sensor required during the measurement.

This ensures permanent, reproducible positioning.

The first force-generating device acts advantageously during the sensor positioning process. The second force-generating device acts advantageously after the positioning of the sensor, but at least during the measuring process.

According to a further advantageous embodiment, at least one device for generating vibrations for exciting the sensor or the adapter is provided.

By generating vibrations, the effect that the bearings position themselves precisely in the counter bearings while the first holding force is generated is enhanced. After this positioning, the second holding force is generated, and maintained permanently at least during the measuring process.

According to a further advantageous embodiment of the invention, it is provided that the measuring system change interface is arranged on the quill of the coordinate measuring machine. The measuring system change interface can be detachably fixed to or at least partially in the quill of the coordinate measuring machine.

The measuring system change interface is advantageously not interchangeable in the usual sense, i.e., arranged on the quill in an automatically interchangeable manner, but the measuring system change interface is advantageously arranged detachably fixed on or at least partially in the quill of the coordinate measuring machine.

The arrangement at least partially in the quill has the advantage that the measuring space of the coordinate measuring machine is enlarged. If the measuring system change interface is located on the quill and outside the quill, the measuring space of the coordinate measuring machine is reduced by the height of the measuring system change interface.

The sensor, for example the probe or an optical sensor, can also be arranged on the quill or at least partially in the quill. The sensor, i.e., the probe or the optical sensor, can also be arranged on the measuring system change interface or at least partially in the measuring system change interface.

If the sensor is arranged at least partially in the quill or in the measuring system change interface, this also saves space and increases the measuring space of the coordinate measuring machine.

The method according to the invention for arranging a sensor or an adapter on a quill or on a reproducible measuring system change interface of a coordinate measuring machine, in which the sensor or the adapter is arranged with counter bearings on bearings of the quill or the measuring system change interface and at least one holding force is generated for the sensor or the adapter, and in which contact is established between a plug and a coupling of at least one supply connection, is characterized in that after the arrangement of the counter bearings of the sensor or the adapter in the bearings of the quill or the measuring system change interface, the plug and/or the coupling of the at least one supply connection is moved.

The method according to the invention has the advantage that the sensor is arranged with counter bearings in the bearings of the quill or the measuring system change interface and that a holding force is generated for the sensor so that the sensor is reproducibly arranged in the bearings of the quill or the measuring system change interface. Subsequently, the plug and/or the coupling of the at least one supply connection is moved in such a way that contact is established between the plug and the coupling. The invention has the advantage that the mounting of the sensor on or at least partially in the quill or the measuring system change interface is unaffected by the design of the contact of the supply connection. The contact of the supply connection is carried out by applying a force that is advantageously lower than the holding force of the sensor. This prevents the coupling or plug from being damaged when making contact between the sensor and the quill or the measuring system change interface if the plug and coupling do not engage properly.

By moving the plug and/or the coupling separately, less force is exerted, so that the plug and coupling are not damaged or are not damaged as severely if they do not engage properly.

The establishment of the contact of the supply connection can also be interrupted if it is detected that the plug and coupling do not engage properly.

According to an advantageous embodiment of the method according to the invention, it is provided that after the arrangement of the counter bearings of the sensor or the adapter in the bearings of the quill or the measuring system change interface, at least one holding force is generated for the sensor or the adapter, and that simultaneously or after the generation of the at least one holding force, the plug or the coupling is moved, and that contact is established between the coupling and the plug.

Advantageously, the sensor is first arranged with the counter bearings in the bearings of the quill or the measuring system change interface and a holding force for the sensor is generated. At the same time or after the holding force is generated, the plug or the coupling is moved so that contact is established between the coupling and the plug.

As already described, this can prevent unwanted forces from acting on the sensor bearing on the quill or the measuring system change interface due to the contact between the plug and the coupling. At the same time, damage to the plug and/or the coupling can be avoided in the event of a fault.

According to a further advantageous embodiment of the method according to the invention, it is provided that a piston carrying the plug or the coupling is arranged in a rest position, that the sensor or the adapter with the counter bearings is arranged in bearings of the quill or the measuring system change interface, that a first force is applied to a holding device for the sensor or the adapter in order to establish contact between the bearings and the counter bearings, that a second holding force is then generated for the sensor or the adapter and that simultaneously with the generation of the second holding force for the sensor or the adapter or after the generation of the second holding force, the plug or the coupling is moved and that contact is established between the plug and the coupling.

This advantageous embodiment of the method according to the invention has the advantage that the two different forces acting on the holding device are generated successively, that is to say consecutively. The first force is used to position the bearings in the counter bearings. The at least one bearing and the at least one counter bearing are brought into contact and/or pre-clamped by generating the first force. By generating the second force, the sensor is clamped on or at least partially in the quill or the measuring system change interface.

This allows for a highly precise and reproducible bearing.

A major advantage is that the process can be carried out in a fully automated manner.

According to a further advantageous embodiment of the method, it is provided that the first holding force is generated by means of springs and that the second holding force is generated pneumatically and that the movement of the plug or the coupling is carried out pneumatically.

The provided spring is lightweight and generates a holding force that reliably enables a pre-positioning of the sensor. The second holding force required for the measurement is advantageously generated pneumatically. This makes it easy to generate the holding force of the sensor required for the measurement.

According to the particularly advantageous embodiment, the movement of the plug or the coupling is carried out pneumatically as well. This makes it possible to couple the pressure connections for generating the second holding force and for moving the plug or the coupling, so that the generation of the second holding force and the force for coupling the plug are generated simultaneously. In addition, this avoids the need for an additional compressed air connection.

According to a further advantageous embodiment of the method according to the invention, it is provided that the second force acts on the holding device in addition to the first force.

This ensures that the sensor is always held by a holding force. The force for the final clamping of the sensor is advantageously greater than the force applied during pre-positioning, so it is advantageous if both forces act on the holding device during the measurement.

According to a further advantageous embodiment of the invention, it is provided that the first force is smaller than the second force. The first force should be relatively small. The force should be large enough to pre-position the bearings in the counter bearings and not yet clamp them. If the clamping were to take place, the rapid, sudden release of the first force would cause the frictional connection to occur suddenly. It can happen that the positioning elements of the bearings and counter bearings do not reach their final positions due to friction, for example. This results in an incorrect position being taken, which leads to incorrect measurements.

According to a further advantageous embodiment of the invention, the feed force for creating the connection between plug and coupling is lower than the holding force with which the sensor is held during the measurement.

Advantageously, the feed force for establishing the connection between plug and coupling is a maximum of 10%, advantageously 5% or less than 5% of the holding force acting on the sensor during a measuring process.

According to a further advantageous embodiment of the invention, it is provided that at least two supply connections are provided, and that the plugs and couplings of the supply connections are brought into contact simultaneously or sequentially.

In principle, it is possible to provide a supply connection that has a plurality of supply lines, for example electrical and/or electronic and/or pneumatic supply lines. However, it is also possible to provide separate supply connections. For example, it is possible to provide electrical and electronic cables in one supply connection and to provide a separate supply connection for a pneumatic supply to the sensor. If different supply connections are provided, these can be brought into contact simultaneously or sequentially.

According to a further advantageous embodiment of the invention, it is provided that the plug or the coupling is moved to an end point on the sensor or on the adapter or to a stop on the quill or on the measuring system change interface.

According to this advantageous embodiment of the invention, it is provided that an end position of the plug in the coupling has an end point and that this end point is advantageously arranged on the sensor or that the end point is designed as a stop on the quill or on the measuring system change interface.

A further advantageous embodiment of the method according to the invention provides that during or after generation of the first force, the sensor or the adapter is moved at least once by a third force. This force can cause the sensor or adapter to shake or vibrate, causing the bearings and counter bearings to assume their specified position relative to each other.

The third force is advantageously generated in the bearing plane. This means that the third force is advantageously generated in the plane in which the bearings and the counter bearings engage.

To release a sensor or an adapter from a quill or a measuring system change interface of a coordinate measuring machine, a holding force of the sensor or the adapter and a holding force for a plug and a coupling are advantageously released.

If the sensor is to be replaced with another sensor, not only the holding force for the sensor is released, but also the holding force for the plug and the coupling of at least one supply connection.

In principle, it is also possible for the sensor to be detached from the quill or the measuring system change interface and for the contact between the plug and the coupling of at least one supply connection to also be automatically released when the sensor is detached.

The coordinate measuring machine according to the invention and the method according to the invention have the advantage that the wear of the contacts of the at least one supply connection is lower than in the supply connections known from practice. Since the contacts are not made with the holding force of the sensor, but with a holding force acting on the plug and the coupling, the wear is lower.

Furthermore, the coordinate measuring machine according to the invention and the method according to the invention have the advantage that the tolerances for the contacts of the at least one supply connection can be larger.

In addition, faulty connections are avoided. If the sensor is pulled into the bearings with the holding force and the contacts between the plug and the coupling of at least one supply connection are formed directly, bent pins can be destroyed, for example, which in turn leads to warranty or recourse claims from customers.

Another advantage is that the design is more flexible. Pins can be rectangular if they are cheaper than round pins, for example. The tolerances can be larger.

If a plurality of supply connections are provided, it is possible to not connect supply connections that are not required when replacing certain sensors. For example, optical sensors do not require a compressed air connection, so this compressed air connection is not connected when an optical sensor is replaced.

It is possible to establish only the necessary contacts.

### BRIEF DESCRIPTION OF THE DRAWINGS

Further features and advantages of the invention result from the associated drawings, in which various embodiments of a coordinate measuring machine according to the invention are shown only as examples, without restricting the invention to these exemplary embodiments. The drawings show:

FIG. 1 a perspective view of a coordinate measuring machine in a portal design;

FIG. 2 a quill with a measuring system change interface, probe and probe holder, partly in longitudinal section;

FIG. 3 a holding device in open side view;

FIG. 4 a longitudinal section of a three-point bearing;

FIG. 5 a plan view of a three-point bearing;

FIG. 6 a counterpart to the three-point bearing of

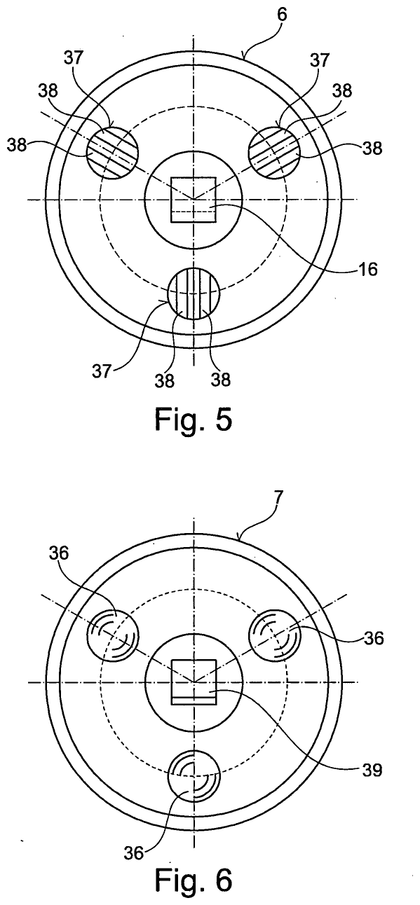

FIG. 5 in top view;

FIG. 7 a longitudinal section of a quill with pivot/swivel joint with probe;

FIG. 8 a holding device in a longitudinal section;

FIG. 9 a detail of FIG. 8 in a longitudinal section;

FIG. 10 a holding device in the open state in a longitudinal section;

FIG. 11 a measuring system change interface with arranged probe in a longitudinal section.

### DETAILED DESCRIPTION OF THE DRAWINGS

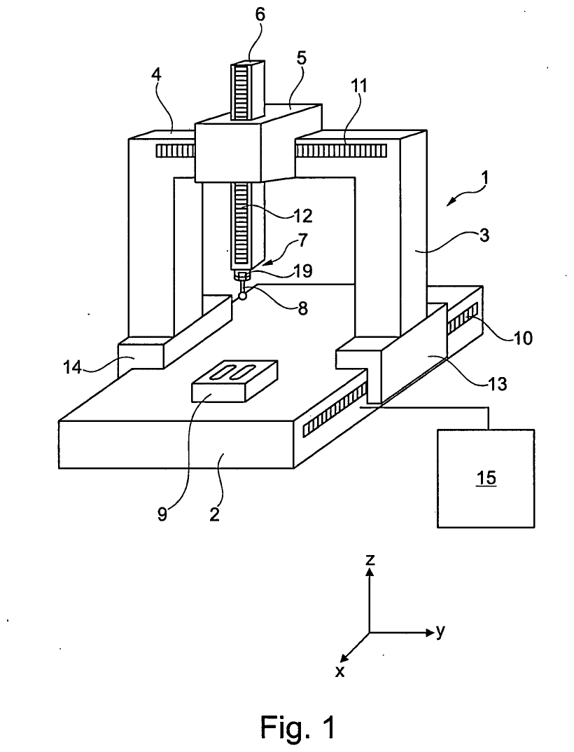

FIG. 1 shows a coordinate measuring machine 1 in portal design with a tool table 2 and a portal 3. The portal 3 has a traverse 4. A carriage 5 is positioned on the traverse 4, on which in turn a quill 6 is positioned. The portal 3 can be moved in the X direction, the carriage 5 in the Y direction, and the quill 6 in the Z direction. A sensor 7 in the form of a probe 7 holding a stylus 8 is positioned on the quill 6. A workpiece 9 is positioned on the measuring table 2 of the coordinate measuring machine.

One scale 10 is positioned on the measuring table 2, one scale 11 on the traverse 4, and one scale 12 on the sleeve 6. The position of the stylus 8 can be detected by means of corresponding distance measuring systems (not shown). The portal 3 has portal feet 13, 14, with which the portal 3 is movably positioned on the measuring table 2. The measured values are recorded and processed via a computer 15, which also contains a control unit.

In principle, there is also the possibility that the portal 3 is fixed in its position and the tool table with the workpiece is moved relative to the portal.

In addition, it is also known to position a rotary table on the tool table 2, for example.

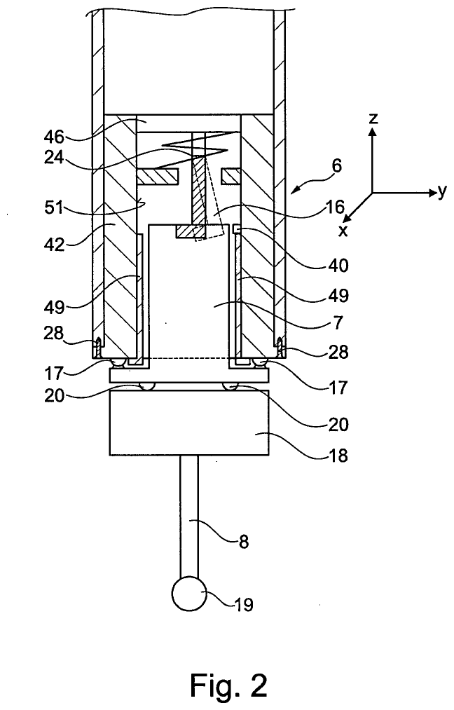

FIG. 2 shows a schematic view of the quill 6. A measuring system change interface 42 and the probe 7 are arranged in the quill 6. The probe 7 is fixed in the quill 6 by means of a three-point bearing 17 by means of a hook 16 that can be pivoted in the Y direction and moved in the Z direction. A stylus holder 18 is positioned on the probe 7 and carries the stylus 8 with a probing element 19. The stylus holder 18 is also detachably attached to the probe 7 by means of a three-point bearing 20. The means for holding the stylus holder 18 are not shown in FIG. 2.

In FIG. 2, a measuring system change interface 42 is provided only schematically. The measuring system change interface 42 has a holding device 46 for the hook 16 for an adapter of a sensor, probe or pivot/swivel joint. The three-point bearing 17 is arranged at the measuring system change interface 42 as well.

The measuring system change interface 42 is arranged at least partially within the quill 6. The measuring system change interface 42 is positioned on the quill 6 with screws 28. The measuring system change interface 42 can be removed from the quill 6 by undoing the screws 28.

A protective device 49 is provided so that the probe 7 is not damaged during the change if it comes into contact with an inner wall the measuring system change interface 42. The protective device 49 is made of plastic, for example. The protective device 49 is flat in FIG. 2. In the embodiment, the protective device 49 is positioned as a segment on an inner surface 51 of the measuring system change interface 42. The protective device 49 can also have a greater axial extension in the direction of a longitudinal axis of the quill 6 than shown in FIG. 2. It can be designed in segments with at least one segment or continuously.

A sensor 40 is arranged in the measuring system change interface 42, which detects whether the probe 7 is in the position shown in FIG. 2, i.e. in which the hook 16 can perform a locking, i.e. a clamping.

After detecting the probe 7 in the locking position, the hook 16 is moved from the dashed position to the hatched position.

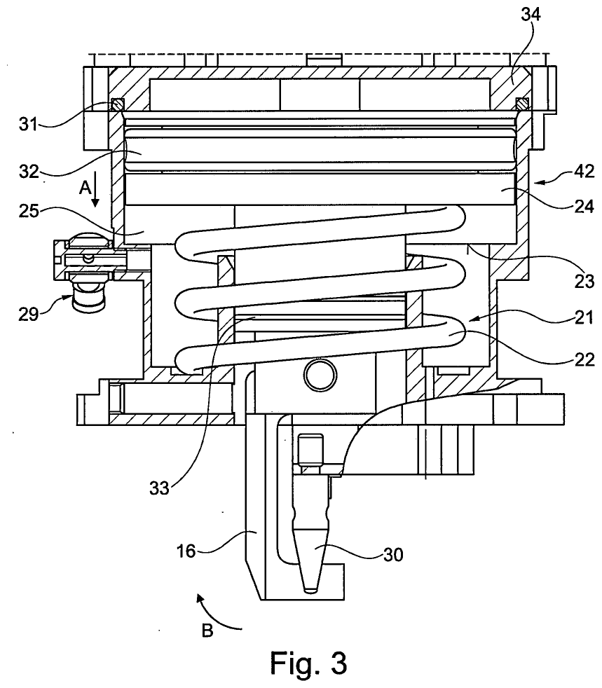

The locking steps are explained in FIG. 3.

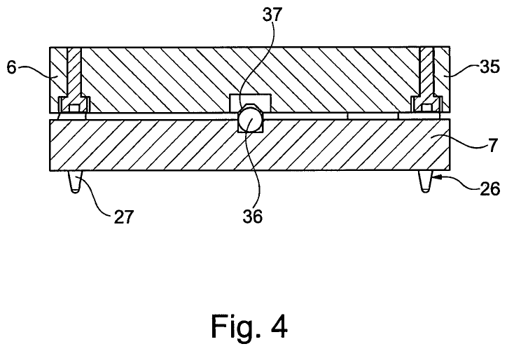

FIG. 3 shows the holding device of the measuring system change interface 46 with the hook 16, which engages behind a plate of an adapter of a sensor, a probe 7 or a pivot/swivel joint 52 (not shown). The hook 16 is acted upon by a first device 21, which consists of a compression spring 22, with a first force having a force component opposite to the direction A shown, which causes a prepositioning of the probe 7 (not shown in FIG. 3). A second device 23, which is formed from a piston 24 pressurized with compressed air, exerts a second holding force with a force component opposite to the direction A shown in the drawing on the hook 16. This second holding force is the additional force that acts on the probe 7 (not shown) during the measuring process. The piston 24 is movably arranged in a chamber 25 which can be pressurized with compressed air. A compressed air connection 29 is provided for the inlet and outlet of compressed air. If the chamber 25 is pressurized with compressed air, the piston 24 is pushed into the position shown in FIG. 3. The hook 16 finally clamps the probe 7 (not shown in FIG. 3). A centering pin 30 is shown in FIG. 3. Typically, a second centering pin, not shown in FIG. 3, is provided to bring the probe 7 (not shown in FIG. 3) into a predefined position for arranging the bearings and counter-bearings, which are described in more detail in FIG. 4 to FIG. 6.

Furthermore, seals 31, 32, 33 are provided so that the chamber 25 is sealed to the outside so that the piston 24 can be moved in the chamber by the compressed air. The piston 24 can be pressurized with compressed air from above and thus moved in the direction of arrow A, so that the compression spring is compressed and the hook 16 can be pivoted in the direction of arrow B and thus releases the probe 7 (not shown in FIG. 3).

If the compressed air system 23 fails, the first device 21 with the compression spring 22 still holds the hook 16 in the position shown in FIG. 3, so that the probe 7 (not shown in FIG. 3) cannot come loose on its own.

The measuring system change interface 42 has a cover 34 which closes the devices 21, 23 upwards in the direction of the quill (not shown).

When the sensor 40 (shown in FIG. 2) detects that the probe 7 is arranged in the position in which the hook 16 can clamp the probe 7, the first device 21, i.e. the compression spring 22, is activated in a first step so that a first holding force acts on the hook 16. The holding force is designed in such a way that the bearings and the counter bearings described in FIG. 4 to FIG. 6 engage correctly. If the bearings and counter bearings do not engage exactly at the beginning of the positioning, the holding force is only large enough for the bearings and counter bearings to assume the correct final position relative to each other. Subsequently, in a second step, the second holding force is automatically applied by the second device 23. The piston 24 is pressurized with compressed air so that it moves in the opposite direction of arrow A and the probe 7 is finally clamped.

Clamping the probe 7 means that the holding force required for a measurement is applied to the probe 7 by the hook 16. The probe 7 is not released from the bearings when an external force is exerted on the probe 7 by the probing.

The probe 7 is removed in the reverse order. The piston 24 is pressurized with compressed air so that it moves in the direction of arrow A. For this purpose, the side of the piston 24 facing the quill (not shown) is pressurized with compressed air.

By applying compressed air to the piston 24 on the side facing away from the spring, the piston 24 is moved in the direction of arrow A. As a result, the piston 24 compresses the spring 22 against the spring force.

The spring 22 then releases the hook 16 so that it moves in the direction of arrow B, i.e., into the dashed position shown in FIG. 2.

Should the second force-generating device 23 fail, the spring 22 pushes the piston 24 upwards in the direction opposite to the arrow. This ensures that the hook 16 does not open and the probe 7 (not shown in FIG. 3) does not become detached unintentionally.

In FIG. 4, a plane 35 between the quill 6 and the probe 7 with the three-point bearing is shown in detail. The three-point bearing consists of the bearings 37 and the counter bearings 36, which are designed as balls or spherical sections. In addition, centering pins 26, 27 are present, which on the one hand pre-center the probe 7 when it is inserted and on the other hand prevent incorrect, i.e. twisted, insertion of the probe 7 if the centering pins 26, 27 are configured asymmetrically.

FIG. 5 shows a plan view of the three-point bearing 17. The quill 6 with the three bearings 37 is shown in FIG. 5. The bearings 37 each have two cylinders 38. In addition, the hook 16 is provided.

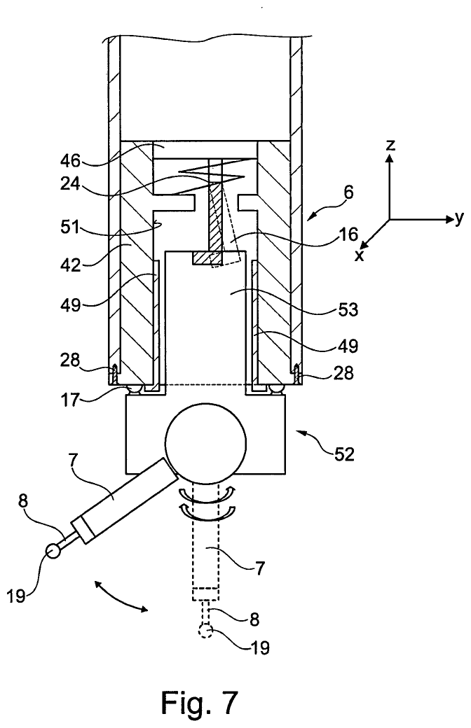

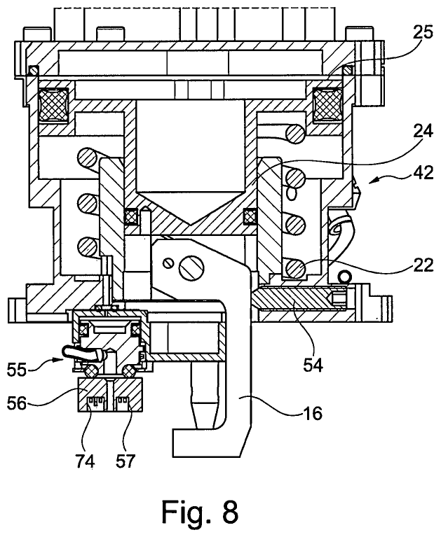

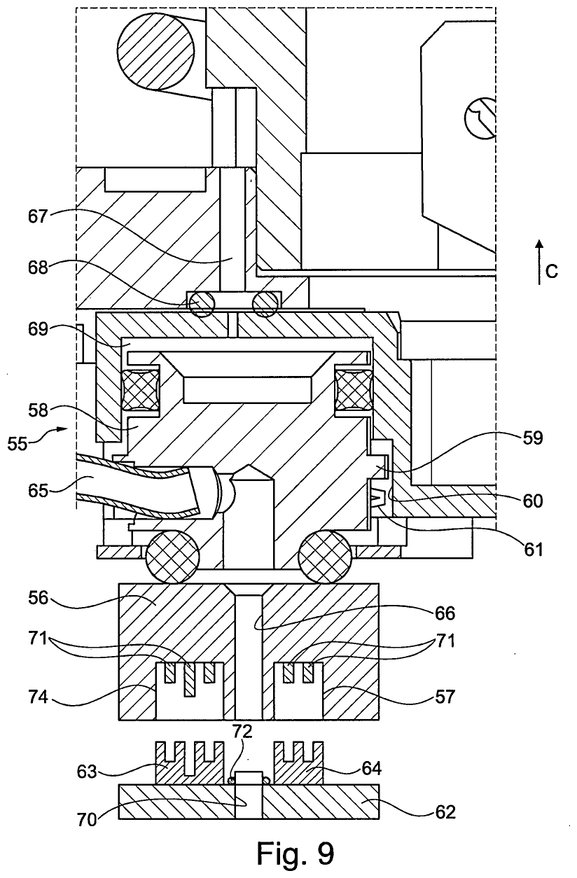

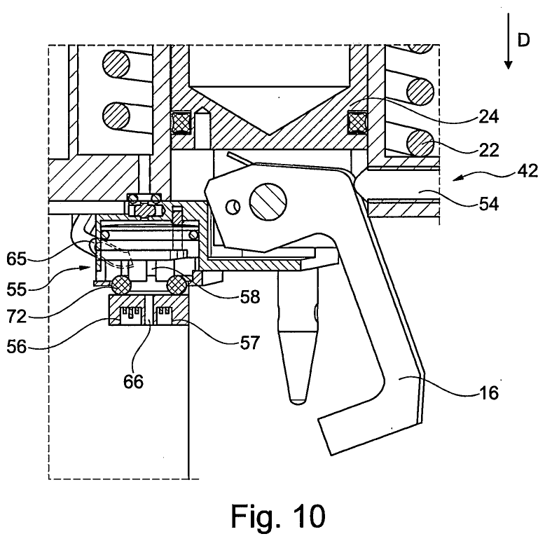

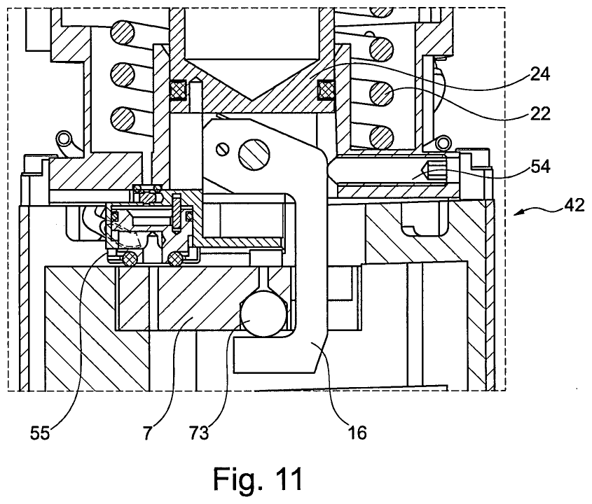

FIG. 6 shows the probe 7, in which three half spheres 36 are positioned. When the probe 7 is positioned on the quill 6, the half spheres 36 come into contact with the cylinders 38 at a total of six points. This achieves reproducible and high-precision bearings. The probe 7 has a receptacle 39 for the hook 16.

FIG. 7 shows the quill 6 with the measuring system change interface 42 arranged in the quill 6. An adapter 53 for a pivot/swivel joint 52 is positioned in the measuring system change interface 42. Instead of the probe 7, as shown in FIG. 2, the adapter 53 for the pivot/swivel joint 52 is positioned in the interface 42. A probe 7 is provided on the pivot/swivel joint 52, on which a stylus 8 with a stylus ball 19 can be positioned so that it can be exchanged. The stylus 8 can be pivoted into the position shown in dashed lines.

The adapter 53 for the pivot/swivel joint 52 is positioned reproducibly in the measuring system change interface 42 by means of the hook 16 and a three-point bearing 17. The protective device 49 protects the adapter 53 from damage when it is exchanged.

The measuring system change interface 42 is positioned within the quill 6. The measuring system change interface 42 is positioned on the quill 6 with screws 28. The measuring system change interface 42 can be removed from the quill 6 by undoing the screws 28.

FIG. 8 shows the measuring system change interface 42 with the compression spring 22, the piston 24 and the chamber 25 that can be pressurized with compressed air. The piston 24 is in an upper position, i.e., the chamber 25 is not pressurized with compressed air, and the spring force acts on the spring 22. The hook 16 is in a closed position because the piston 24 has moved upwards and a pin 54 presses the hook 16 into the position shown in FIG. 8.

In addition, a supply connection 55, which has a coupling 56, is provided. The coupling 56 has receptacles 57, 74 into which the plugs (not shown in FIG. 8) of a sensor 7 (not shown in FIG. 8) engage.

The supply connection 55 is shown in FIG. 9. The receptacles 57 and 74 are shown only schematically.

The supply connection 55 has a piston 58 which has a shoulder 59. The shoulder 59 is designed as a circumferential shoulder and arranged in a groove 60. In addition, a spring 61 is arranged in the groove 60, which is designed as a compression spring.

The spring force of the compression spring 61 pushes the piston 58 into a rest position in the direction of arrow C. A plug 62, which has the plug contacts 63, 64, is shown only schematically. The plug 62 is arranged on a probe 7 (not shown in FIG. 9).

The supply connection 55 has a compressed air connection 65. This compressed air connection serves as the air supply for the probe 7. The compressed air is passed through a hole 66. Another compressed air connection 67, which is sealed by an O-ring 68, leads air into a chamber 69. If compressed air is applied to the compressed air connection 67, the piston 58 is pushed downwards in the direction opposite to the arrow C. The receptacles 57, 74 sit on the plug contacts 63, 64 and establish a contact. In addition, the hole 66 creates a connection to the hole 70, so that a compressed air connection for the probe is available via the plug 62. The plug contacts 63, 64 create an electrical or electronic contact with the pins 71 of the receptacles 57, 74 of the coupling 56.

FIG. 10 shows the measuring system change interface 42 with an open hook 16. The piston 24 has been moved in the direction of the arrow D. The pin 54 releases the hook 16 so that it can swing open.

The supply connection 55 with the couplings 56, 57 is shown only schematically.

In FIG. 10, the piston 58 is in an upper end position, i.e., the supply connection is arranged in a rest position. An O-ring 72 is used to seal the compressed air connection.

FIG. 11 shows the measuring system change interface 42 with the piston 24, the compression spring 22, the hook 16 and the supply connection 55. The probe 7 is arranged at the measuring system change interface 42. The hook 16 is in a closed position. The pin 54 holds the hook 16 in the closed position. The hook 16 engages behind a ball 73 of the probe 7 and thus holds the probe 7 at the measuring system change interface 42.

For arranging the probe 7 at the measuring system change interface 42, the supply connection 55 is located as shown in FIG. 9.

The probe 7 is arranged at the measuring system change interface 42 and the bearings 37 come into contact with the counter bearings 36, which are designed as spherical sections. Subsequently, the chamber 69 is pressurized with compressed air, as shown in FIG. 9. The piston 58 moves opposite to the direction of arrow C, so that the receptacles 57, 74 and the hole 66 for the compressed air connection come into contact with the plug contacts 63, 64 of the plug 62.

Because the supply connection 55 is not arranged on the plug 62 with the holding force of the probe 7, damage to pins 71 or the receptacles 57, 74 in the plug contacts 63, 64 is avoided, since the force acting on the piston 58 is significantly smaller than the holding force for the probe 7.

### REFERENCE NUMBERS

1 coordinate measuring machine
2 tool table
3 portal
4 traverse
5 carriage
6 quill
7 sensor (probe)
8 stylus
9 workpiece
10 scale
11 scale
12 scale
13 portal foot
14 portal foot
15 computer
16 hook
17 three-point bearing
18 stylus holder
19 probing element
20 three-point bearing
21 first device
22 compression spring
23 second device
24 pistons
25 space that can be pressurized with compressed air
26 centering pin
27 centering pin
28 screws
29 compressed air connection
30 centering pin
31 seal
32 seal
33 seal
34 lid
35 plane of the three-point bearing
36 counter bearing
37 bearing
38 cylinder
39 receptacle
40 sensor
42 measuring system change interface
46 holding device
49 protective device
51 inner surface of the measuring system change interface
52 pivot/swivel joint
53 pivot/swivel joint adapter
54 pin
55 supply connection
56 coupling
57 receptacle
58 piston
59 shoulder
60 groove
61 spring
62 plug
63 plug contact
64 plug contact
65 compressed air connection
66 hole
67 compressed air connection
68 O-ring
69 chamber
70 hole
71 pins
72 O-ring
73 ball
74 receptacle
A arrow
B arrow
C arrow

1. A coordinate measuring machine with a sensor arranged on one of a quill, on a measuring system change interface, or with an adapter for a sensor and with a bearing device which has at least one bearing arranged on one of the quill or on the measuring system change interface, and at least one counter bearing arranged on one of the sensor or the adapter, and with a holding device for one of the sensor or the adapter arranged on one of the quill or on the measuring system change interface, and with at least one supply connection arranged between one of the quill or the measuring system change interface and the sensor or the adapter, wherein the at least one supply connection has a plug and a coupling, wherein one or more of-the plug or the coupling is arranged so as to be movable on the quill or on the measuring system change interface and/or on the sensor or the adapter.

2. The coordinate measuring machine according to claim 1, wherein one of the plug or the coupling is arranged on one of the quill or on the measuring system change interface, and that one of the plug or the coupling is designed to be pneumatically, electrically, and/or hydraulically movable.

3. The coordinate measuring machine according to claim 1, wherein one of the plug or the coupling is arranged on a piston, the piston is movably mounted in a cylinder, and the cylinder is configured to be pressurized with compressed air.

4. The coordinate measuring machine according to claim 3, wherein a holding device is provided for one of the sensor or the adapter, wherein the holding device comprises a first compressed air connection for generating a holding force of one of the sensor or the adapter, wherein a second compressed air connection is provided for the at least one supply connection, wherein both the first and the second compressed air connections are configured to be coupled.

5. The coordinate measuring machine according to claim 1, wherein one of the plug or the coupling is arranged in one of the sensor or in the adapter, and at least one motor is provided in one of the sensor or the adapter for moving one of the plug or the coupling.

6. The coordinate measuring machine according to claim 4, wherein at least two force-generating devices are arranged in or on the measuring system change interface, which are configured as at least two force-generating devices acting on the holding device, wherein a first force-generating device is configured as a spring, wherein a second force-generating device is configured as a pneumatically operated piston.

7. The coordinate measuring machine according to claim 6, wherein the first force-generating device configured as a spring is configured as a force-generating device at least during a positioning of one of the sensor or the adapter, wherein the second force-generating device is configured as a device generating a holding force after the positioning of one of the sensor or the adapter.

8. The coordinate measuring machine according to claim 1, wherein at least one device for generating vibrations for exciting the sensor is provided.

9. A method for arranging one of a sensor or an adapter on one of a quill or a reproducible measuring system change interface of a coordinate measuring machine, wherein one of the sensor or the adapter is arranged with counter bearings on bearings of one of the quill or the measuring system change interface and at least one holding force is generated for one of the sensor or the adapter, wherein a contact is established between a plug and a coupling of at least one supply connection, wherein after the arrangement of the counter bearings of one of the sensor or the adapter in the bearings of one of the quill or the measuring system change interface, one or more of the plug and/or the coupling of the at least one supply connection is moved.

10. The method according to claim 9, wherein after the arrangement of the counter bearings of one of the sensor or the adapter in the bearings of one of the quill or the measuring system change interface, at least one holding force for one of the sensor or the adapter is generated, wherein simultaneously or after the generation of the at least one holding force, one of the plug or the coupling is moved and contact is established between the coupling and the plug.

11. The method according to claim 9, wherein a piston carrying one of the plug or the coupling is arranged in a rest position, wherein one of the sensor or the adapter with the counter bearings is arranged in the bearings of one of the quill or the measuring system change interface, wherein a first holding force is applied to a holding device for one of the sensor or the adapter in order to establish contact between the bearings and the counter bearings, wherein a second holding force is generated for one of the sensor or adapter, and simultaneously with the generation of the second holding force for one of the sensor or adapter or after the generation of the second holding force, one of the plug or the coupling is moved, and contact is established between the plug and the coupling.

12. The method according to claim 11, wherein the first holding force is generated by means of at least one spring, the second holding force is generated pneumatically, and the movement of one of the plug or the coupling is carried out pneumatically.

13. The method according to claim 9, wherein at least two supply connections are provided, wherein plugs and couplings of the supply connections are brought into contact one of simultaneously or sequentially.

14. The method according to claim 9, wherein one of the plug or the coupling is moved to an end point on one of the sensor, the adapter, to a stop on the quill, or to the measuring system change interface.

15. The method according to claim 11, wherein a prepositioning of one of the sensor or the adapter in an end position is carried out by generating the first holding force.

16. The method according to claim 11, wherein the second holding force acts on the holding device in addition to the first holding force.

17. The method according to claim 11, wherein the first holding force is smaller than the second holding force.

18. The method according to claim 11, wherein one of the sensor or the adapter is moved at least once by a third holding force during or after the generation of the first holding force.
